(19) United States
(12) Patent Application Publication
(10) Pub. No.: US 2009/0074176 A1
(43) Pub. Date: Mar. 19, 2009

(54) TELEPHONE SYSTEM

(75) Inventors: Toshiki Mori, Tokyo (JP); Yoshiro Osaki, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/181,687

(22) Filed: Jul. 29, 2008

(30) Foreign Application Priority Data
Sep. 19, 2007 (JP) 2007-242979

(51) Int. Cl. H04M 3/00

(52) U.S. Cl. 379/310

(57) ABSTRACT

The telephone system includes a server apparatus storing telephone directory data distinguished by extension numbers, and telephone terminals individually corresponded to the extension numbers by login operation. The telephone terminal has a user interface section which receives a request operation for requesting a reference to the telephone directory data which is specified by the extension number, and the request section which sends out the request message containing the extension number specified in the request operation to the server apparatus. Moreover, the server apparatus has a transmission section which transmits the telephone directory data corresponding to the extension number contained in a request message to the telephone terminal which sent out the request message.

### CROSS REFERENCE TO RELATED APPLICATION

This application is based upon and claims the benefit of priority from the Japanese Patent Application No. 2007-242979, filed on Sep. 19, 2007, the entire contents of which are incorporated herein by reference.

### FIELD OF THE INVENTION

This invention relates to a telephone system used for an extension telephone system in office, etc.

### DESCRIPTION OF THE BACKGROUND

A system which realizes a voice telephone call through an IP (Internet Protocol) network is known. This system is called an IP telephone system or a VoIP (Voice over IP). Since the IP is a general-purpose communications protocol in communication between computers, if the IP telephone system is used, a cooperation function of the telephone system and the computer can be built flexibly. In recent years, connecting an IP telephone with the computer on a LAN (Local Area Network) in office and operating those cooperatively is performed.

As a function that is often used in this kind of telephone system, there is a telephone directory function described in, for example, the Japanese Patent Application Laid-open Disclosure No. Hei 5-260176. This is the function which each telephone user calls a telephone directory created beforehand by terminal operation and can call automatically at a registered telephone number by one push.

The telephone directories are the data corresponded to each of the telephones as a database only for individuals, and are usually stored collectively in a system server.

As long as the telephone is assigned to everybody for exclusive use and each one uses its own telephone, there is especially no problem since each one can use its own telephone directory. However, when using other person's telephone temporarily, or when using a telephone placed in a common space, such as a conference room, the user cannot refer to the telephone directory only for the user. Therefore, if the other party's telephone number is not memorized, the user is required to return to its own seat etc. and there is a problem that it is inconvenient for the user.

### SUMMARY OF THE INVENTION

Accordingly, it is an object of the invention is to provide a telephone system that addresses the above problem and improves usability of a telephone directory function. In accordance with one embodiment of this invention, the telephone system includes a server apparatus storing telephone directory data distinguished by extension numbers, and telephone terminals individually corresponded to the extension numbers by login operation. The telephone terminal further includes a user interface section which receives a request operation for requesting a reference to the telephone directory data which is specified by the extension number, and the request section which sends out the request message containing the extension number specified in the request operation to the server apparatus. Moreover, the server apparatus has a transmission section which transmits the telephone directory data corresponding to the extension number contained in a request message to the telephone terminal which sent out the request message.

### BRIEF DESCRIPTION OF THE DRAWINGS

FIG. 1 is a system diagram showing a telephone system according to a first embodiment.

FIG. 2 is a pattern diagram showing an appearance of an IP telephone.

FIG. 3 is a functional block diagram showing the IP telephone of FIG. 1.

FIG. 4 is a functional block diagram showing a system server of FIG. 1.

FIG. 5 is a diagram showing a telephone directory database of FIG. 3.

FIG. 6 is a flow chart showing a procedure for acquiring a telephone directory data at the time of starting of the IP telephone.

FIG. 7 is a flow chart showing call operation using a telephone directory function.

FIG. 8 is a flow chart showing a procedure performed in the telephone system according to the first embodiment.

FIG. 9 is a diagram showing a telephone directory database of a telephone system according to a second embodiment.

### DETAILED DESCRIPTION OF THE INVENTION

According to the first embodiment, a telephone system has a server apparatus which stores two or more telephone directory data distinguished by extension numbers, and two or more telephone terminals corresponded to the extension numbers by login operation. The telephone terminal has a user interface section which receives the request operation for requesting the reference of the telephone directory data specified by the extension number and the request section which sends the request message containing the extension number specified in the request operation to server apparatus. Moreover, server apparatus has a transmission section which transmits the telephone directory data corresponding to the extension number contained in the request message to the telephone terminal which sent the request message.

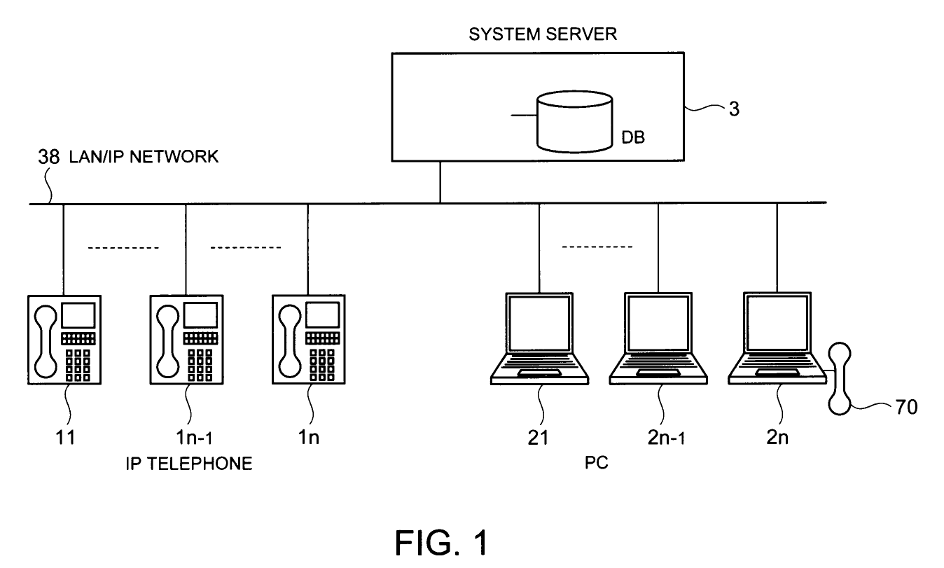

As shown in FIG. 1, in the telephone system, a plurality of IP telephones 11-1n, a plurality of personal computer (PC) terminals 21-2n and system server 3 are connected through LAN/IP network 38. PC terminal 2n has an IP telephone function. System server 3 performs call control according to a call connection request between IP telephones 11-1n and PC terminal 2n, or from an outside line telephone of a public network which is not shown.

In the system as shown in FIG. 1, it is common to control the function concerning the telephone by using SIP (Session Initiation Protocol). For example, login/logout function, which makes the system recognized IP telephones 11-1n and PC terminal 2n equipped with IP telephone function and which makes those seceded from the system, is performed using a REGISTER message of the SIP. A user inputs its extension number, an ID (Identification) number and an authentication code (password) from the IP telephone in a login process. If the login process is completed normally, the user can use the IP telephone logged in as a terminal only for the user. System server 3 makes a connection among an IP address of the IP telephone logged in, a telephone number and an extension number, and manages them in database section DB.

Further the system shown in FIG. 1 has PC terminals 21-2n-1 related with IP telephone 11-1n-1 respectively. For example, IP telephone 11 is related with PC terminal 21, and IP telephone 11 and PC terminal 21 are put on the same user's desk and operate cooperating mutually. By making IP telephone and PC terminal cooperate, a telephone directory data can be displayed on a large display of PC terminal 21-2n, and click to dial to call a desired party from the IP telephone by clicking a telephone number displayed on the display, can be realized. The SIP is used also in order to associate IP telephone 11-1n-1 with the PC terminal 21-2n-1. However, IP telephone in is not associated with PC terminal 2n, IP telephone in is provided independently. Moreover, PC terminal 2n is installed with a software phone which includes an IP telephone software and a handset 70, and PC terminal 2n is provided independently.

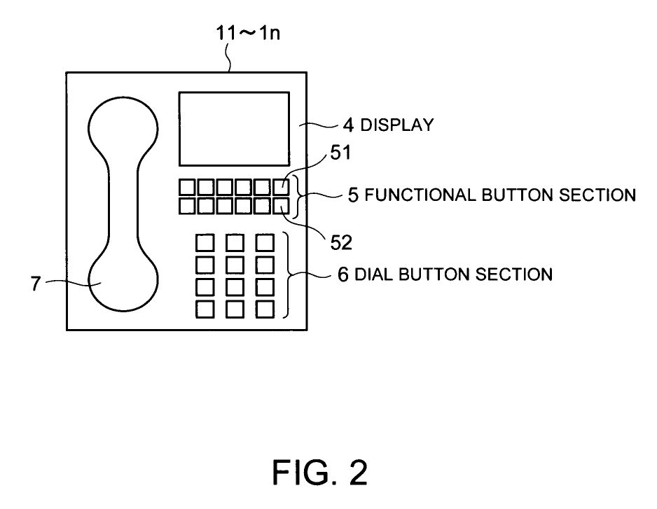

FIG. 2 is a pattern diagram showing the appearance of IP telephones 11-1n. IP telephone 11-1n has display section 4, such as LCD (Liquid Crystal Display), and is possible to display a self state. When for example, IP telephone 11-1n is in a state under an incoming call, a telephone call, etc., a partner's telephone number, a name, etc. are displayed on display section 4. Information for displaying those is contained in a message which notifies the incoming call, or a message which notifies a partner's response. In order to notify those various kinds of information, SIP messages, for example, a request message and a response message responding to the request message, are used. In addition to those, IP telephones 11-1n has functional button section 5, dial button section 6 and handset 7.

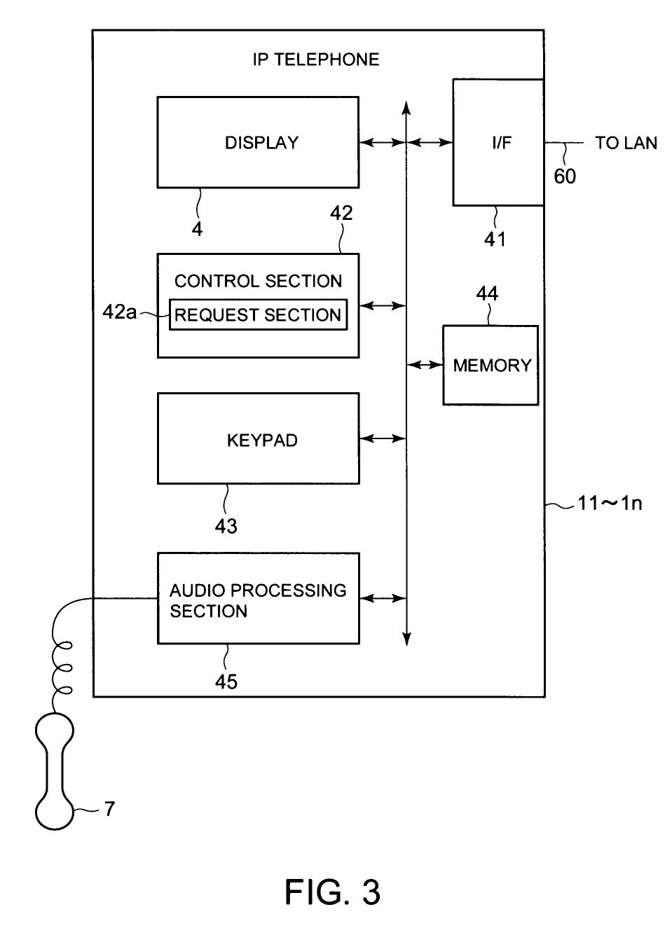

FIG. 3 is the functional block diagram showing IP telephone 11 of FIG. 1 according the first embodiment. IP telephones 12-1n has the same construction as IP telephone 11. IP telephone 11 includes interface (I/F) section 41, display section 4, control section 42, keypad section 43, memory 44 and audio processing section 45. I/F section 41 is connected with the LAN through LAN cable 60, and mediates transfer of the data between system server 3 and its own terminal (IP telephone 11). Handset 7 is connected to audio processing section 45. In addition, as for PC terminal 2n, the same function is constituted by software and hardware.

Display section 4 displays various messages visually. Keypad section 43 has functional button section 5 and dial button section 6 as shown in FIG. 2, and keypad section 43 functions as a user interface for receiving input operation by the user. Particularly keypad section 43 has functional button 51 in functional button section 5 for performing a telephone directory reference function concerning this embodiment. Hereafter, functional button 51 used for this use will be called an “other's telephone directory button”.

Control section 42 has request section 42a as a processing function concerning this embodiment. A program for realizing the function is stored in memory 44. If other's telephone directory button 51 is pushed, request section 42a will receive the request operation for requesting the reference of the telephone directory data of the telephone of other extension number. And request section 42a generates the request message including the extension number of the IP telephone which is referred to and specified in this request operation, and sends the request message to system server 3.

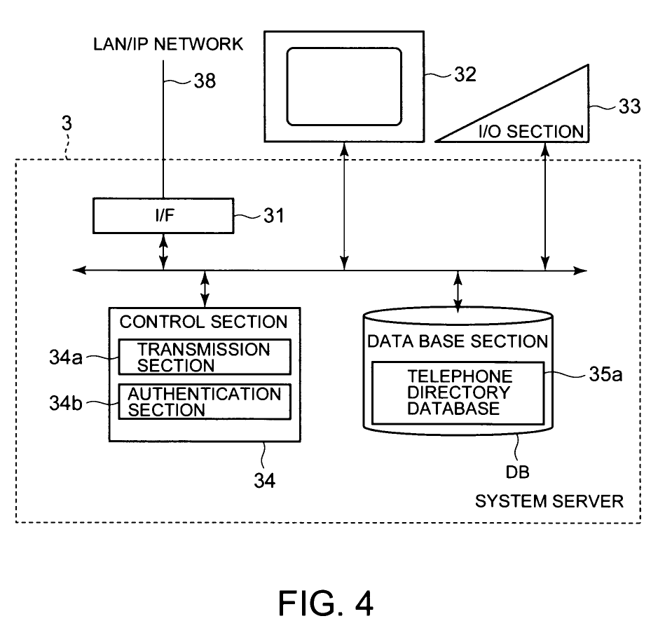

FIG. 4 is the functional block diagram of system server 3 shown in FIG. 1. In FIG. 4, system server 3 has interface (I/F) section 31 connected to LAN/IP network 38 shown in FIG. 1, display section 32, input-and-output (I/O) section 33, control section 34, and database section DB. Database section DB stores telephone directory database 35a to a storage region of exclusive use.

Control section 34 has transmission section 34a and authentication section 34b as processing functions concerning this embodiment. Transmission section 34a reads the requested telephone directory data from telephone directory database 35a according to the request message which requests transmission of the telephone directory data, and transmits the telephone directory data to the IP telephone which requests the telephone directory data. In that case, the telephone directory data is not sent blindly but there are various conditions.

Authentication section 34b authenticates the user of the IP telephone who requested a transmission of the telephone directory data. This authentication processing is different from the authentication in the login process, and it is for determining the propriety of the data transmission to the user who requests the transmission of the telephone directory data. That is, in this embodiment, in requesting of the telephone directory data from the IP telephone, it is required to input the extension number of the telephone directory data to refer to, and the authentication number. Authentication section 34b authenticates the user by the extension number and the authentication number that were inputted. Transmission section 34a transmits the telephone directory data only to the IP telephone which the user who succeeded in authentication is using.

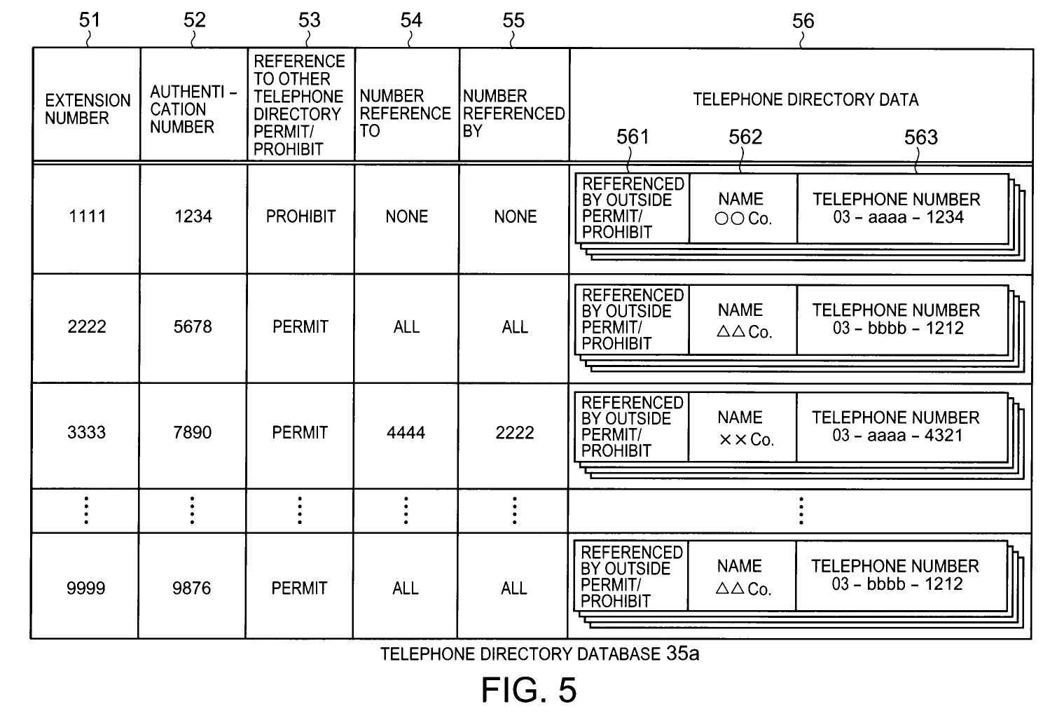

FIG. 5 is the diagram showing details of telephone directory database 35a shown in FIG. 4. Telephone directory database 35a is a database which consolidates management of the telephone directory data assigned to the user of each of IP telephones 11-1n and PC terminal 2n. Hereinafter, the detail will be explained. Each user's extension number is managed in column 51, and telephone directory database 35a has the structure which has various kinds of data corresponding to the extension number. That is, each user is distinguished by the extension number and the telephone directory data for every user is corresponding to the extension number.

Moreover, in database 35a, the authentication number which authenticates the user who uses the telephone directory data is corresponding to the extension number, and is registered in column 52.

Furthermore, attributions on the extension number and an attribution on the telephone directory data are given individually, and those attributions are registered in columns 53-55.

First, in column 53, “REFERENCE TO OTHER TELEPHONE DIRECTORY PERMIT/PROHIBIT” which is an attribution on the extension number is registered. This attribution is for discriminating whether the reference of the telephone directory data of other extension number from the IP telephone of a certain extension number is permitted, or prohibited.

According to this attribution, it is decided whether the transmission of the telephone directory data to the IP telephone of the extension number which required the transmission of the telephone directory data is permitted or prohibited. For example, since extension number 1111 is “prohibit”, the IP telephone of extension number 1111 cannot refer the other's telephone directory data. On the other hand, since extension numbers 2222, 3333 and 9999 are “permit”, the IP telephones of these extension numbers can refer to the other's telephone directory data.

Next, in column 54, “NUMBER REFERENCE TO” which is an attribution on the extension number is registered. This attribution specifies the telephone directory data of other extension numbers which the IP telephone of a certain extension number can refer to. That is, it is the information for specifying the telephone directory data which can be referred to from the IP telephone of the extension number. Transmission section 34a transmits only the telephone directory data of the extension number specified in column 54.

For example, since extension number 1111 is “NONE”, the IP telephone of the extension number 1111 can not refer to the telephone directory data of any of other extension number. Since extension number 2222 is “ALL”, the IP telephone of the extension number 2222 can refer to the telephone directory data of all other extension numbers. Furthermore since extension number 3333 specifies “4444”, the IP telephone of extension number 3333 can refer to the telephone directory data of only extension number 4444. In addition, although only extension number of “4444” is permitted as a party can be referred to in FIG. 5, it is also possible to describe two or more extension numbers of parties.

Next, in column 55, “NUMBER REFERENCED BY” which is an attribution on the telephone directory data is registered. This specifies the extension number of the IP telephone which can refer to the telephone directory data of a certain extension number. That is, it is the information for specifying IP telephone which is permitted to refer to the telephone directory data by the extension number. Transmission section 34a transmits the requested telephone directory data only to the IP telephone of the extension number specified in column 55.

For example, since extension number 1111 is “NONE” in FIG. 5, none of the IP telephone can refer to the telephone directory data of extension number 1111. On the other hand, since extension number 2222 is “ALL”, all of the IP telephones can refer to the telephone directory data of extension number 2222. In case of extension number 3333, since “2222” is specified as a requesting telephone, the telephone directory data of extension number 3333 can be referred only by the IP telephone of extension number 2222. If two or more telephone numbers are specified about this attribution, only those IP telephones specified can refer to the telephone directory data. The columns 53-55 above can be provided as a system option. In addition, when applying combining two or three of these conditions, it is necessary to set the priority of application among each condition so that inconsistency may not occur.

Main part of the telephone directory data is registered in column 56. For every extension number, partner's name 562 and telephone number 563 are registered as a pair. Plural pairs are registered if there are two or more partners. Moreover, an attribution “REFERENCED BY OUTSIDE PERMIT/PROHIBIT” in column 561 can also be given to each data as the attribution which distinguishes whether the reference from other telephone is permitted or prohibited. Fine operation can be specified by providing attribution column 561. For example, it can be specified that a part of the data is not permitted to be referred to even if the requirement of column 55 is filled.

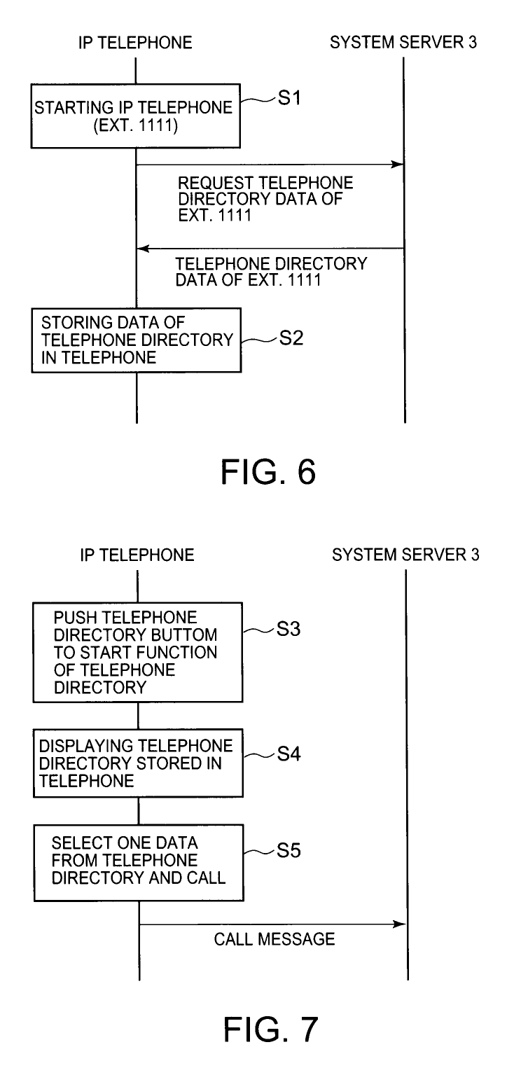

Next, a function of the above-mentioned structure will be explained. First, a procedure for acquiring telephone directory data at the time of starting of the IP telephone will be explained. FIG. 6 is the flow chart showing the sequence. An electric power is supplied to the IP telephone of extension number 1111, for example, and the telephone directory data corresponding to extension number 1111 is requested to system server 3 with starting of the IP telephone by the login process mentioned above (Step S1). System server 3 which received this request reads the telephone directory data corresponding to extension number 1111 from telephone directory database 35a, and sends the telephone directory data to the IP telephone requested them. The IP telephone which received the telephone directory data stores the telephone directory data in memory 44 (Step S2). This flow chart shows the procedure in which the IP telephone acquires the telephone directory data corresponding to its own extension number.

FIG. 7 is the flow chart showing call operation using a telephone directory function. The telephone directory function is started when telephone directory call button 52, for example, provide in functional button section 5 is pushed (Step S3). Then the IP telephone reads the telephone directory data stored in memory 44, and displays the telephone directory by a list at display section 4 (Step S4). If one partner's name is chosen from the telephone directory, the IP telephone starts call operation using the telephone number registered in the telephone directory, and sends out a call message (INVITE message) containing the partner's telephone number to system server 3 (Step S5).

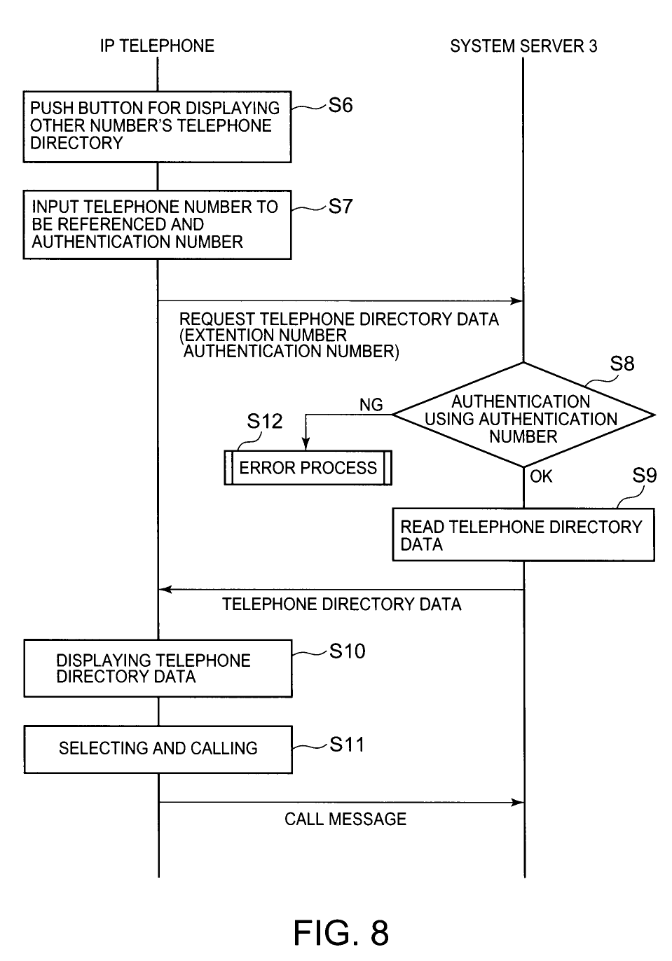

Next, a peculiar procedure to this embodiment will be explained. FIG. 8 is the flow chart showing the procedure performed in the telephone system according to the embodiment. In FIG. 8, if other's telephone directory display button, that is, other's telephone directory button 51 in functional button section 5 is pushed (Step S6), the function for referring to the other's telephone directory data starts. Then the user inputs the extension number of the telephone directory data to be referred to and the authentication number corresponding to the extension number (Step S7). The telephone directory data requested by the user is not stored in memory 44 of the IP telephone at this stage.

Next, the IP telephone transmits the request message containing the extension number and the authentication number inputted at Step S7 to system server 3. When system server 3 receives the request message, system server 3 authenticates a request person by checking a combination of the authentication number and the extension number first (Step S8). If the authentication is succeeded, system server 3 reads the telephone directory data corresponding to the requested extension number from telephone directory database 35a (Step S9), and transmits the telephone directory data to the IP telephone which requested. In addition, if the authentication is failed, an error process such as displaying a message “Authentication is error” on display section 4 of the IP telephone is performed (Step S12).

Then, the IP telephone newly stores the telephone directory data received in memory 44 and displays a list of names and telephone numbers on display section 4 (Step S10). After this, as like FIG. 7, the INVITE message to the selected partner is sent out to system server 3 (Step S11).

In addition, the telephone directory data referred to is desirable to be deleted on security. For example, the IP telephone is configured to delete the telephone directory data stored in memory 44 when “OTHER'S TELEPHONE DIRECTOY” button 51 is pushed again.

The telephone directory data can be referred to by each IP telephone in the procedure shown in FIGS. 6 and 7 is limited to the telephone directory data which is registered only for the IP telephone beforehand. That is, for example, the IP telephone of extension number 1111 can acquire only the telephone directory data of extension number 1111 as shown in FIG. 5.

In the telephone system according to this embodiment, the attention was paid to the fact that all users' telephone directory data are stored in system server 3, and the telephone system is configured so that the telephone directory data corresponding to the extension number can be acquired from other IP telephones by specifying extension number. That is, the function is started by pushing other's telephone directory button 51, and if the extension number of the telephone directory data to be referred to and the authentication number are inputted, the request message containing the extension number and the authentication number is sent to system server 3. System server 3 returns the telephone directory data corresponding to the extension number to the IP telephone requesting the other's telephone directory data. In that case, system server 3 authenticates the authentication number inputted with the extension number, and propriety of the transmission of the telephone directory data is judged. Since the system is thus configured, individual telephone directory data can be prevented from being referred to from unspecified number of users, and leakage of personal information can be prevented even in a system which requires a severe security management like an extension telephone line system in office.

Thus, in the telephone system according to the embodiment, the telephone directory data of the other IP telephone of the extension number, which is different from the extension number of the IP telephone under operation, becomes possible to be acquired by specifying the extension number. Therefore, since the telephone directory data which the user created becomes possible to be referred to from other telephone in the telephone system, usability is improved. Moreover, the registration of the authentication number can also prevent the user who does not know the authentication number from referring to the telephone directory data. From these things, it becomes possible to provide the telephone system which improved usability of the telephone directory function.

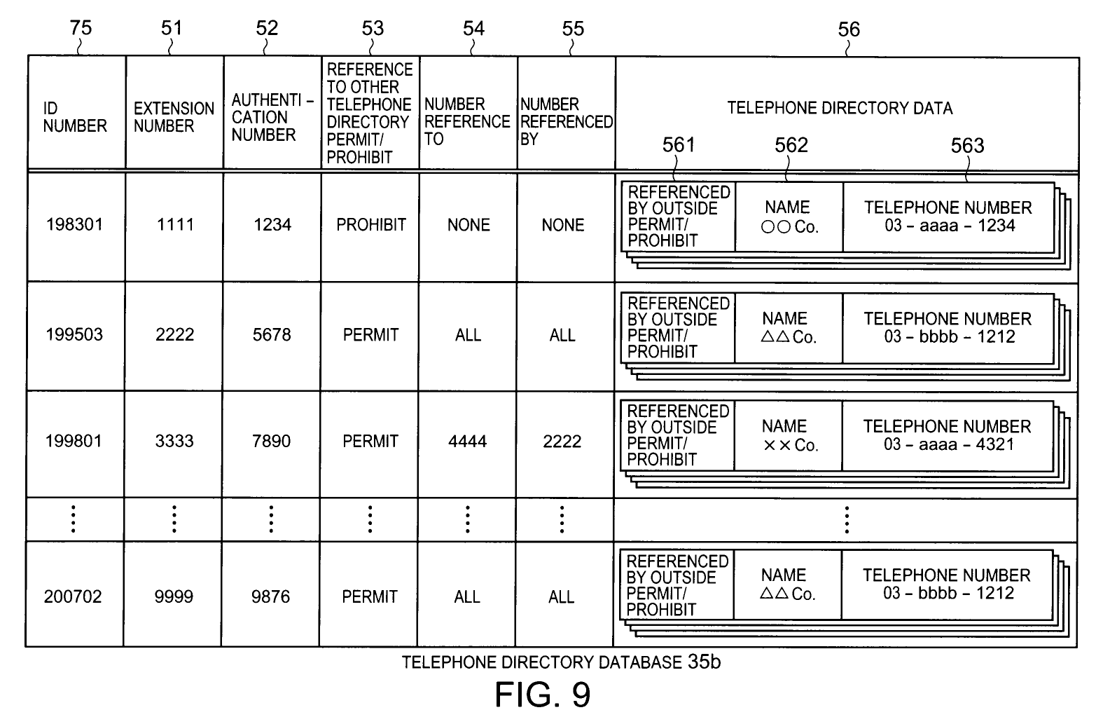

Next, the telephone system according to the second embodiment will be explained. The telephone system according to the second embodiment has a structure similar to the structure according to the first embodiment. However, a structure of a telephone directory database is different from that of the first embodiment. FIG. 9 shows telephone directory database 35b according to the second embodiment. In telephone directory database 35b, column 75 is added to telephone directory database 35a shown in FIG. 5. An identification number which identifies a user is registered in column 75, and telephone directory database 35b has a structure in which unitary management is performed by the identification number. For this reason, when referring to other's telephone directory data, unlike the telephone system according to the first embodiment, the telephone directory data which is wanted to be referred to is specified by the identification number, not the extension number. In addition, the ID number inputted by the login process, an employee number, etc. can be used as for the identification number. That is, the telephone system has the server apparatus which stores two or more telephone directory data distinguished by the identification number which identifies a user, and two or more telephone terminals corresponded to extension numbers by the login operation. And the telephone terminal has the user interface section which receives the request operation for requesting the reference of the telephone directory data specified by the identification number, and the request section which sends the request message containing the identification number specified in the request operation to the server apparatus. Moreover, the server apparatus has the transmission section which transmits the telephone directory data corresponding to the identification number contained in the request message to the telephone terminal which sent out the request message. Also according to this embodiment, the telephone system which improved usability of the telephone directory function is provided like the first embodiment.

In addition, this invention is not limited to the above-mentioned the embodiment. For example, the authentication number is not necessary, and if security can be loose, the telephone directory data can be referred to without the input of the authentication number. Moreover, it is common to display both the name and the telephone number in displaying telephone directory data by the IP telephone or the PC terminal, however, only the name may be displayed and the telephone number may not be displayed when referencing the telephone directory from other telephones. And if the call operation can be made only by specifying a name, the telephone number itself can be concealed from the user.

Moreover, not only the above-mentioned embodiment, in order to delete the telephone directory data, the IP telephone is configured so that a delete button is provided and the telephone directory data is deleted when the delete bottom is pushed. Furthermore, the IP telephone can be configured so that the telephone directory data is automatically deleted when a predetermined time passes after the telephone directory data is read from the system server using a timer.

Moreover, although the telephone directory data are not deleted, the IP telephone can be configured so that referring again to the telephone directory data is forbidden if the IP telephone makes a call once. In this case, if another telephone directory data is read, the another telephone directory data is overwritten in a same region of the memory. Moreover, the request message for other's telephone directory data can be divided into one message having an “extension number” and the other message having a “personal identification number” by the interactive operation between the IP telephone and server 3, and can be sent to server 3.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A telephone system, comprising:
a server apparatus storing two or more telephone directory data distinguished by extension numbers; and
two or more telephone terminals corresponded to the extension numbers by login operation,
wherein
the telephone terminal has a user interface section being configured to receive a request operation for requesting reference to the telephone directory data specified by the extension number, and a request section being configured to send out a request message containing the extension number specified in the request operation to the server apparatus; and
the server apparatus has a transmission section being configured to transmit the telephone directory data corresponding to the extension number contained in the request message to the telephone terminal which sent out the request message.

2. The telephone system according to claim 1, wherein the user interface section includes a functional button for an exclusive use for the request operation.

3. The telephone system according to claim 1, wherein the server apparatus stores an authentication number corresponding to the extension number.

4. The telephone system according to claim 3, wherein the user interface section requests input of the authentication number in the request operation, the request section includes the authentication number inputted in the request message, the server apparatus has an authentication section being configured to compare the authentication number contained in the request message with the authentication number stored in the server apparatus, and the transmission section transmits the telephone directory data corresponding to the extension number contained in the request message if an authentication by the authentication section is successful.

5. The telephone system according to claim 1, wherein the server apparatus stores an attribution on the extension number.

6. The telephone system according to claim 5, wherein the attribution on the extension number is information for specifying either permission or prohibition of transmission of the telephone directory data to the telephone terminal, and the transmission section transmits the telephone directory data corresponding to the extension number contained in the request message if the attribution on the extension number of the telephone terminal that sent the request message is permission.

7. The telephone system according to claim 5, wherein the attribution on the extension number is information for specifying the telephone directory data which can be referred to from the telephone terminal and the transmission section transmits the telephone directory data corresponding to the extension number contained in the request message only if the extension number contained in the request message is specified in the attribution.

8. The telephone system according to claim 1, wherein the telephone directory data has an attribution for specifying the telephone terminal which is permitted to refer to the telephone directory data, and the transmission section transmits the telephone directory data corresponding to the extension number contained in the request message only to the telephone terminal of the extension number specified in the attribution.

9. The telephone system according to claim 1, wherein the telephone terminal is a software phone containing software and hardware installed in a personal computer.

10. The telephone system according to claim 1, wherein the telephone terminal is configured to delete the telephone directory data transmitted from the transmission section.

11. The telephone system according to claim 1, wherein the telephone terminal has a button to delete the telephone directory data transmitted from the transmission section.

12. A telephone system, comprising:
a server apparatus storing two or more telephone directory data distinguished by identification numbers; and
two or more telephone terminals corresponded to extension numbers by login operation,
wherein
the telephone terminal has a user interface section being configured to receive a request operation for requesting a reference to the telephone directory data specified by the identification number and a request section being configured to send out a request message containing the identification number specified in the request operation to the server apparatus, and
the server apparatus has a transmission section being configured to transmit the telephone directory data corresponding to the identification number contained in the request message to the telephone terminal which sent out the request message.
